(19) United States
(12) Patent Application Publication
(10) Pub. No.: US 2023/0123430 A1
(43) Pub. Date: Apr. 20, 2023

(54) GROUNDED MULTIMODAL AGENT INTERACTIONS

(71) Applicant: Microsoft Technology Licensing, LLC, Redmond, WA (US)

(72) Inventors: William B. DOLAN, Kirkland, WA (US); Christopher John BROCKETT, Kirkland, WA (US); Ryan VOLUM, Seattle, WA (US); Gabriel A. DESGARENNES, Issaquah, WA (US); Sudha RAO, Bothell, WA (US)

(73) Assignee: Microsoft Technology Licensing, LLC, Redmond, WA (US)

(21) Appl. No.: 17/517,378

(22) Filed: Nov. 2, 2021

Related U.S. Application Data
(60) Provisional application No. 63/255,840, filed on Oct. 14, 2021.

(51) Int. Cl. G06F 40/106; G06N 20/00; G06F 40/166; G06F 40/30

(52) U.S. Cl. CPC G06F 40/106; G06N 20/00; G06F 40/166; G06F 40/30

(57) ABSTRACT

Aspects of the present disclosure relate to grounded multimodal agent interactions, where a user input is processed using a multimodal machine learning model to generate model output. The model output may then be processed to affect the behavior of an application, for example to enable a user to control the application and/or to facilitate user interactions with a conversational agent, among other examples. In some instances, at least a part of the model output may be executed or parsed, for example to call an application programming interface or function of the application. Thus, use of a multimodal machine learning model according to aspects described herein may enable the use of user-provided natural language input to affect the behavior of an application accordingly.

### CROSS-REFERENCE TO RELATED APPLICATION

This application claims priority to U.S. Provisional Application No. 63/255,840, titled “Grounded Multimodal Agent Interactions,” filed on Oct. 14, 2021, the entire disclosure of which is hereby incorporated by reference in its entirety.

### BACKGROUND

A user may provide natural language input for processing by a conversational agent. Similarly, the conversational agent may generate natural language output that is provided in response to the user, thereby enabling the user and the conversational agent to communicate. However, interactions between the user and the conversational agent may thus be restricted to natural language, which may result in reduced utility of the conversational agent to the user and/or limited richness of such interactions.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to grounded multimodal agent interactions, where a user input is processed using a multimodal machine learning model to generate model output. The model output may then be processed to affect the behavior of an application, for example to enable a user to control the application and/or to facilitate user interactions with a conversational agent, among other examples. In some instances, at least a part of the model output may be executed or parsed, for example to call an application programming interface or function of the application. Thus, use of a multimodal machine learning model according to aspects described herein may enable the use of user-provided natural language input to affect the behavior of an application accordingly.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for grounded multimodal agent interactions according to aspects described herein.

FIG. 2 illustrates an overview of an example method for affecting an application based on model output from a multimodal machine learning model according to aspects described herein.

FIG. 3 illustrates an overview of an example method for generating a multimodal response according to aspects described herein.

FIG. 4 illustrates an overview of an example method for controlling a productivity application using a multimodal generative platform according to aspects described herein.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user and a conversational agent interact using natural language, where user input is processed using a generative machine learning model to generate natural language output. The natural language output may then be provided in response to the user input. However, using a generative machine learning model in such a way may limit the utility of the conversational agent, for example to contexts in which natural language interactions alone can achieve an objective of a user. Further, as a result of being restricted only to natural language communication, such interactions may lack richness or depth, which may therefore also diminish the associated user experience. For instance, a conversational agent interacting solely using natural language may be unable to affect an application state to facilitate user interactions with the application.

Accordingly, aspects of the present disclosure relate to grounded multimodal agent interactions. In examples, a generative multimodal machine learning model processes user input and generates multimodal output. For example, a conversational agent according to aspects described herein may receive user input, such that the user input may be processed using the generative multimodal machine learning model to generate multimodal output. The multimodal output may comprise natural language output and/or programmatic output, among other examples. The multimodal output may be processed and used to affect the state of an associated application. For example, at least a part of the multimodal output may be executed or may be used to call an application programming interface (API) of the application. A generative multimodal machine learning model (also generally referred to herein as a multimodal machine learning model herein) used according to aspects described herein may be a generative transformer model, in some examples. In some instances, explicit and/or implicit feedback may be processed to improve the performance of multimodal machine learning model.

In examples, user input and/or model output is multimodal, which, as used herein, may comprise one or more types of content. Example content includes, but is not limited to, written language (which may also be referred to herein as “natural language output”), code (which may also be referred to herein as “programmatic output”), images, video, audio, gestures, visual features, intonation, contour features, poses, styles, fonts, and/or transitions, among other examples. Thus, as compared to a machine learning model that processes natural language input and generates natural language output, aspects of the present disclosure may process input and generate output having any of a variety of content types.

It will be appreciated that all inputs and outputs for a content agent and its associated machine learning model need not be multimodal in nature. Rather, an input or output may have a single content type. For example, a user may provide input to a conversational agent that is only natural language, such that the conversational agent provides programmatic output in response, among other examples. Thus, a machine learning model according to aspects described herein may be termed to be multimodal as a result of its ability to process multiple content types. For instance, in the above example, the machine learning model interoperates between natural language and programmatic content types.

As a result of the multimodal nature of a machine learning model used by a conversational agent as described herein, a user may interact with the conversational agent to affect an application state. Examples include, but are not limited to, manipulating one or more parameters of the application, causing interactions similar to those offered by a control surface of an application (e.g., relating to a user interface element, a gesture, a keystroke, mouse input, or a menu item), causing execution of an API call, or manipulating or otherwise controlling generation of one or more types of content (e.g., textual, visual, and/or auditory content). Additional examples of such aspects are discussed in greater detail below.

Returning to the above example of multimodal interactions associated with natural language and programmatic content, natural language input received from a user may be processed to generate programmatic output, such that at least a part of the programmatic output may be executed. For example, a user may provide an instruction as natural language input, such that the machine learning model generates programmatic output that causes an application to behave as instructed by the user. For instance, the programmatic output may be a series of programmatic steps that are executed or otherwise performed by the application, thereby performing one or more complex tasks associated with an application. Similarly, the machine learning model may generate natural language output in addition to or as an alternative to such programmatic output. In some examples, such natural language output may itself be in the form of programmatic output, for example comprising code similar to a comment or a “print” or “echo” function.

While a machine learning model may be fine-tuned for one or more specific scenarios (examples of which are discussed in greater detail below), aspects of the present application may be performed using a machine learning model that has not been specialized for such a specific scenario. As an example, a multimodal machine learning model may be primed or grounded using a prompt or other context to bias the machine learning model toward a specific behavior. For example, a prompt may provide one or more multimodal examples that illustrate a relationship between multiple content types. Thus, a prompt may be designed or generated to increase the likelihood that a model exhibits a specific behavior. In some examples, one or more such prompts may be distributed and/or (re)used in specific contexts, such that the same machine learning model may be used to reproduce different behaviors in different scenarios (e.g., where each scenario may have an associated prompt).

Returning to the above example of natural language and programmatic content, a prompt in such an example may include a text comment and an associated code segment, thereby priming the machine learning model to process similar natural language input and generate similar programmatic output. While example prompts are described, it will be appreciated that any of a variety of techniques may be used to prime a machine learning model to perform the multimodal processing aspects described herein. For instance other techniques may be used to associate two types of content (e.g., other than a comment and associated code) Similarly, it will be appreciated that, in some examples, a machine learning model may not be primed or grounded as described above, as may be the case when a machine learning model has been fine-tuned for a given scenario.

In examples, a context may be maintained for interactions with a conversational agent. For example, a context may include a prompt as well one or more instances of user input and associated model output. Thus, such a context may enable a conversational agent to learn from previous interactions with a user, for example to correct machine learning model behavior, define new behaviors, and/or perform introspection on previous behavior, among other examples. Any of a variety of techniques may be used to maintain a context associated with a conversational agent, for example in association with a specific user, a specific user session, a specific set of users, or more generally for a larger population of users. As another example, a context may include a predetermined number of previous interactions or a machine learning model may have a limited attention with which such context affects model output generated by the machine learning model.

As used herein, a conversational agent may perform processing based on model output, for example as may be generated based on user input associated with a user. For example, the conversational agent may be a virtual assistant or a non-player character (NPC). Some examples, the conversational agent may have a visual manifestation (e.g., a virtual avatar or graphical representation), aspects of which may be controlled based on model output according to aspects described herein. In other examples, the conversational agent may be functionality integrated into an application, such that it may not have a visual manifestation. For example, a user may provide natural language input into a text box or as spoken dialogue to the application, such that the input is processed (e.g., by a conversational agent of the application) to affect behavior of the application accordingly.

In example interactions between a user and a conversational agent according to aspects described herein, user input may be received, an indication of which may be provided to a multimodal machine learning model in association with a prompt, such that the machine learning model generates model output accordingly. As noted above, the user input and the resulting model output need not be the same content type. Rather, in some examples, at least a part of the model output may be a content type that is different from the user input. The model output is processed to affect the behavior of an application, thereby enabling user control of various aspects of an application using natural language input (or any of a variety of alternative or additional types of input, in other examples).

For instance, model output obtained from a multimodal machine learning model may include programmatic output that is executed to control the behavior of the application. As an example, natural language user input may be received indicating a user request to change the formatting and/or transitions of one or more sections, merge documents, or create or modify a formula of a spreadsheet, among other examples to affect the behavior of a productivity application. Accordingly, the user input is processed by the multimodal machine learning model according to aspects described herein to generate programmatic output that includes a set of programmatic steps, which, when executed, cause the productivity application to implement the user-requested behavior.

In an example where the user requests that multiple sections are highlighted according to one or more criteria, the generated programmatic output may include a first programmatic step that causes the productivity application to identify sections according to the criteria, a second programmatic step that causes the productivity application to select the identified sections, and a third programmatic step that causes the productivity application to highlight the selected sections. Thus, aspects described herein enable a user to invoke complex application functionality using natural language input, which may be tedious or difficult to achieve via a user interface or may otherwise be unavailable to the user altogether.

As noted above, the user input and/or model output may form a context that is used in subsequent interactions with the conversational agent. As an example, when a subsequent user interaction is received, a context is provided in association with the subsequent user interaction, which includes the prompt in addition to the previous user input and/or model output. Accordingly, subsequent model output is received, which may similarly be processed to the model output discussed above. Thus, subsequent user interactions with the conversational agent may be iterative in nature, where context is maintained to enable a user to correct machine learning model behavior, define new behaviors of the machine learning model and associated output, and/or request that the machine learning model perform introspection on previous behavior, among other examples. As noted above, a context may not be maintained in other examples.

In some instances, a model may fail to generate adequate model output. For example, it may be determined that a confidence level associated with the model output is below a predetermined threshold. As another example, while a multimodal machine learning model may attempt to generate content having a specific content type, the generated content may be invalid. Returning to the example or programmatic output, the resulting model output may be syntactically and/or semantically invalid, such that it is not usable to affect application behavior. For example, the model output may not conform to a specific API or may reference a user interface element or other functionality that does not exist. In such instances, an indication may be provided that a user input was not understood correctly or the user may be prompted to reformulate the provided input, among other examples. In some examples, the user input and associated model output may be stored for subsequent use as training data so as to improve model performance in the future.

As noted above, a multimodal machine learning model may be fine-tuned in some examples, for example to incorporate additional and/or more specific knowledge for a given scenario. As an example, the multimodal machine learning model may be trained using content associated with a specific scenario or domain in which it will likely be used. In the example of programmatic output, the machine learning model may be trained using relevant documentation, libraries, and code examples. Thus, in addition to or as an alternative to using a prompt to prime the machine learning model, such tuning may be used to facilitate interoperability between user input and model input having various content types. Additionally, training data generated as a result of user interactions with a conversational agent may be used to improve model performance, for example based on inputs and outputs that are logged in instances where the machine learning model fails to generate adequate model output.

Thus, aspects of the present disclosure enable more natural user interactions with a conversational agent that extend beyond simpler natural language conversation. Further, as compared to slot filling or other natural language processing techniques that map natural language input to specific application behaviors, generated model output may be more dynamic, as a machine learning model may effectively learn from user interactions and subsequently generate corrected model output accordingly. Further, rather than rigidly filling slots according to tokens identified within user input, generated model output may be adapted for any of a variety of scenarios as a result of associated prompts, context, and/or fine-tuning. In general, aspects of the present disclosure enable a user experience having tangible, technical results stemming from the application of multimodal machine learning model output to affect the behavior of an application as a result.

Aspects of the present disclosure may enable interactive development and debugging. For example, user input may be processed to generate programmatic model output, which may be executed or otherwise used to affect application behavior according to aspects described herein. Such processing may enable a user to observe an effect of the generated programmatic model output, such that the user may provide subsequent user input to correct the behavior of the machine learning model. As a result, subsequent output from the machine learning model may be improved as compared to the previous model output (e.g., by virtue of a context maintained in association with the user's interaction with the conversational agent) Similarly, user input may result in model output that exhibits new behaviors that would not have previously been generated by the machine learning model. For example, user input may correct model output syntax, API calls, or other content. As another example, the resulting model output and associated processing may enable a user to access functionality of an application that may not otherwise be (easily) accessible to a user, for example as a result of combining functionality associated with multiple controls and/or control surfaces of the application.

Aspects of the present disclosure may be used to control aspects of a productivity application. Example productivity applications include, but are not limited to, a word processor, a spreadsheet editor, a presentation editor, an image editor, an audio editor, a video editor, a calendaring application, a task manager, an email application, a business analytics/data visualization application, a virtual and/or augmented reality application, or a computer-aided design (CAD) application. In examples, a productivity application has one or more associated productivity objects, such as a rich text document, an email, a calendar appointment, a task, a spreadsheet, a presentation or one or more slides therein, a dashboard (e.g., to provide business intelligence or resource monitoring), a web page, an image, an audio file or stream, and/or a video, among documents having any of a variety of other content types. Additionally, a productivity application need not be restricted to productivity objects of a single content type. While some examples herein are described with respect to a document of a productivity application, it will be appreciated that such examples are applicable to any of a variety of productivity objects.

Accordingly, functionality, other parameters, and/or one or more documents of a productivity application may be controlled or otherwise affected based on user input and associated interactions with a conversational agent (e.g., which may be received as natural language input). For example, the user input may be processed to generate model output associated with one or more API calls, user interface elements, or other commands of the productivity application.

In some instances, processing the model output may affect a document or other content of the productivity application. For example, content within a document may be added, removed, or revised. As an example, natural language audio content may automatically be generated based on content of a productivity document. As another example, aspects described herein may additionally or alternatively result in changes (e.g., adding, removing, or modifying) relating to formatting, transitions, graphics or images, and/or formulas (e.g., in a word processing document or a spreadsheet document). For instance, model output may affect productivity application functionality without explicitly including content for inclusion in the document of the productivity application.

Thus, model output may have any of a variety of types, each of which may affect any of a variety of aspects of a productivity application as described herein. It will be appreciated that a single multimodal machine learning model need not be used to generate all of these and other content types. Rather, in other examples, a set of such multimodal machine learning models may be used, where each machine learning model may have at least a partially overlapping set of associated content types.

Similar to the above-discussed debugging aspects, a user may iteratively refine behavior exhibited by the conversational agent in instances where model output and resulting behavior is not what the user expects. In some instances, model output may ultimately yield a macro, where functionality of the productivity application is combined in response to a user input, such that the user may invoke the macro to affect behavior of the productivity application accordingly. In instances where model behavior is refined, a previous change to a document may be reverted in favor of processing associated with subsequent model output.

A prompt associated with a productivity application (or set of productivity applications) may be used according to aspects described herein. For example, a prompt may include natural language and an indication of associated functionality of a productivity application (e.g., as an API call, a function call, or macro name, among other examples). It will be appreciated that a prompt may include linguistic priming, programmatic priming, and/or priming associated with any of a variety of other content types. In a further example, a prompt may include code or other programmatic definitions associated with dynamically accessing one or more variables or other aspects of the productivity application.

In the context of a productivity application, any of a variety of user input may constitute a user interaction that is processed by a conversational agent. For example, a user may provide explicit user input to the conversational agent (e.g., via a chat pane or in the form of a comment associated with at least a part of a document). As another example, a user may modify content of a document, which may be processed by a conversational agent to determine whether the behavior of the productivity application can be affected accordingly.

According to aspects described herein, model output may be generated based on a prompt and/or a context. In examples, the context may be associated with the user, with one or more productivity applications, with a set of documents (e.g., as may be associated with the same or different productivity applications), and/or a session, among other examples. In some instances, the context may enable the behaviors discussed above, as may be the result of interactive debugging and/or the creation of functionality akin to macros.

In some instances, the same or a similar context as is associated with one productivity application and/or document may be applied to another productivity application and/or document. For example, the context may be applied for each productivity application in conjunction with an associated prompt, thereby adapting the context to yield model output that is similar but instead usable by each respective productivity application. Such aspects may enable the portability of user-developed behaviors as well as the ability to request that a model perform introspection with respect to interactions associated with a different productivity application and/or document.

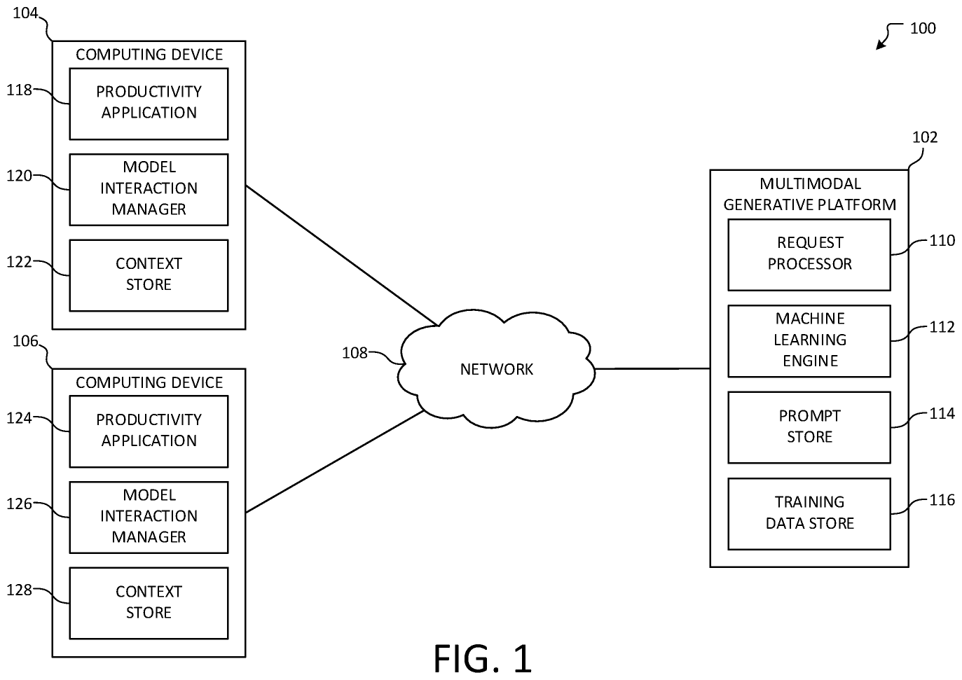

FIG. 1 illustrates an overview of an example system 100 for grounded multimodal agent interactions according to aspects described herein. As illustrated, system 100 comprises multimodal generative platform 102, computing device 104, computing device 106, and network 108. In examples, multimodal generative platform 102, computing device 104, and/or computing device 106 communicate via network 108, which may comprise a local area network, a wireless network, or the Internet, or any combination thereof, among other examples.

While system 100 is described in an example where processing is performed using a machine learning model that is remote to computing devices 104 and 106 (e.g., at multimodal generative platform 102), it will be appreciated that, in other examples, at least some aspects described herein with respect to a multimodal generative platform may be performed locally to computing device 104 and/or computing device 106.

Multimodal generative platform 102 is illustrated as comprising request processor 110, machine learning engine 112, prompt store 114, and training data store 116. In examples, request processor 110 receives a request from computing device 104 and/or computing device 106 (e.g., from model interaction manager 120 and model interaction manager 126, respectively) to generate model output (e.g., as may be generated by machine learning engine 112). For example, the request may include an indication of user input and/or a prompt or context, among other examples. In some instances, the request includes an indication of a prompt stored by prompt store 114 or, as another example, model interaction manager 120 may request a prompt from prompt store 114, which may subsequently be provided in a request to generate model output.

Machine learning engine 112 may comprise a multimodal machine learning model according to aspects described herein. For example, machine learning engine 112 may include a multimodal machine learning model that was trained using a training data set having a plurality of content types (e.g., associated with one or more types of user input that may be received from computing device 104 and/or 106, as well as one or more types of model output to be generated in response). Thus, given content of a first type, machine learning engine 112 may generate content of the first type and/or content of the second type.

Multimodal generative platform 102 is further illustrated as comprising prompt store 114, which may facilitate distribution of prompts with which model output may be generated according to aspects described herein. For example, a prompt stored by prompt store 114 may have an associated version, such that prompts used by computing device 104 and/or computing device 106 may be updated accordingly. In other instances, prompt store 114 stores a prompt (and, in some examples, an associated context) in association with a specific user or group of users (e.g., of computing device 104 and/or computing device 106), or a given application (e.g., productivity application 118 and/or productivity application 124), among other examples.

Training data store 116 may store training data associated with machine learning engine 112. In examples, training data store 116 is updated based on instances when it is determined that model output of machine learning engine 112 is inadequate (e.g., based on an associated confidence level or an indication received from model interaction manager 120 and/or model interaction manager 126, among other examples), such that machine learning engine 112 may subsequently be retrained to improve its performance.

As illustrated, computing device 104 includes productivity application 118, model interaction manager 120, and context store 122. Similarly, computing device 106 includes productivity application 124, model interaction manager 126, and context store 128. Aspects are described below with reference to computing device 104. However, computing device 106 may be similar to computing device 104, and, as such, aspects of computing device 106 are not necessarily re-described below in detail.

In examples, productivity application 118 may be a native application or a web-based application. Productivity application 118 may implement one or more conversational agents according to aspects described herein. For example, such conversational agents may be implemented as a virtual assistant or as functionality of productivity application 118 that enables model output-based control of productivity application 118 in response to received user input. It will be appreciated that, in other examples, aspects of productivity application 118 (as well as model interaction manager 120 and/or context store 122, in some examples) need not be local to computing device 104 and may instead by implemented remotely, for example by one or more game servers (not pictured).

Accordingly, model interaction manager 120 may process received user input to facilitate the generation of model output according to aspects described herein. For example, model interaction manager 120 may determine a prompt with which the received user input will be processed (e.g., as may be associated with a conversational agent of productivity application 118), such that an indication of the determined prompt and the user input is provided to multimodal generative platform 102 (e.g., where it is received by request processor 110 and processed by machine learning engine 112 to generate model output). In response, model interaction manager 120 receives generated model output. In examples, at least a part of the user input and/or generated model output may be stored in context store 122 as context (e.g., in association with the conversational agent for which the user input was received), such that the context may be used in subsequent requests for model output from multimodal generative platform 102.

Model interaction manager 120 may process the model output to affect the behavior of productivity application 118 according to aspects described herein. For example, the model output may include any of a variety of types of content, each of which may affect certain aspects of productivity application 118. As an example, the model output may include programmatic output, which may be executed, parsed, or otherwise processed by model interaction manager 120 (e.g., as one or more API calls or function calls). As another example, the model output may include natural language or other document-related output, which may be used to update the content of a document of productivity application 118 accordingly.

As noted above, the model output may control any of a variety of other aspects of productivity application 118, for example relating to formatting, transitions, graphics or images, and/or formulas within a document of productivity application 118. Thus, while example processing and associated content types are described, it will be appreciated that model interaction manager 120 may use any of a variety of techniques to process multimodal model output according to aspects of the present disclosure.

In some instances, model interaction manager 120 may determine that the model output is inadequate, as may be the case when the model output has an associated confidence level that is below a predetermined threshold, an indication of an error or other issue is received from multimodal generative platform 102 in addition to or as an alternative to the model output, or processing of at least a part of the model output fails (e.g., as may be the case when the model output includes code or other output that is syntactically or semantically incorrect), among other examples. In such instances, model interaction manager 120 may provide a failure indication to the user, for example indicating that the user may retry or reformulate the user input, that the user input was not correctly understood, or that the requested functionality may not be available. While example issues and associated issue handling techniques are described, it will be appreciated that any of a variety of other issues and/or issue handling techniques may be encountered/used in other examples.

In examples, the same machine learning model (e.g., machine learning engine 112) may be used to affect the behavior of any number of productivity applications and/or in association with any of a variety of documents/content types. In such examples, model interaction manager 120 may determine a different prompt for each productivity application and/or document. Further, at least a part of the prompt may change depending on the state of productivity application 118 (e.g., depending on the type of document that is open within productivity application 118 or according to a user preference, for example to enable or disable certain application functionality).

System 100 is illustrated as having computing device 104 and computing device 106 to illustrate that machine learning engine 112 may be used by multiple computing devices to generate any of a variety of model outputs associated with productivity application 118 and productivity application 124, respectively. In examples, prompts and/or context used by model interaction managers 120 and 126 may be different or may be similar (e.g., as may be the case when context is shared among a set of users or computing devices 104 and 106 share the same user). In other examples, multimodal generative platform 102 may have a context store in which conversational agent context may be stored.

In some instances, multimodal generative platform 102 may include multiple machine learning engines, for example associated with different productivity applications (e.g., as may be the case when a machine learning engine has been fine-tuned for a given scenario), such that request processor 110 may determine a machine learning engine with which to process a request received from model interaction manager 120 and/or model interaction manager 126. Further, while aspects are described with respect to generating model output using a single multimodal generative machine learning model, it will be appreciated that, in other examples, multiple such models may be used. For example, a first multimodal generative machine learning model may have an associated first set of content types, while a second multimodal generative machine learning model may have an associated second set of content types, at least some of which may be different from the first set of content types.

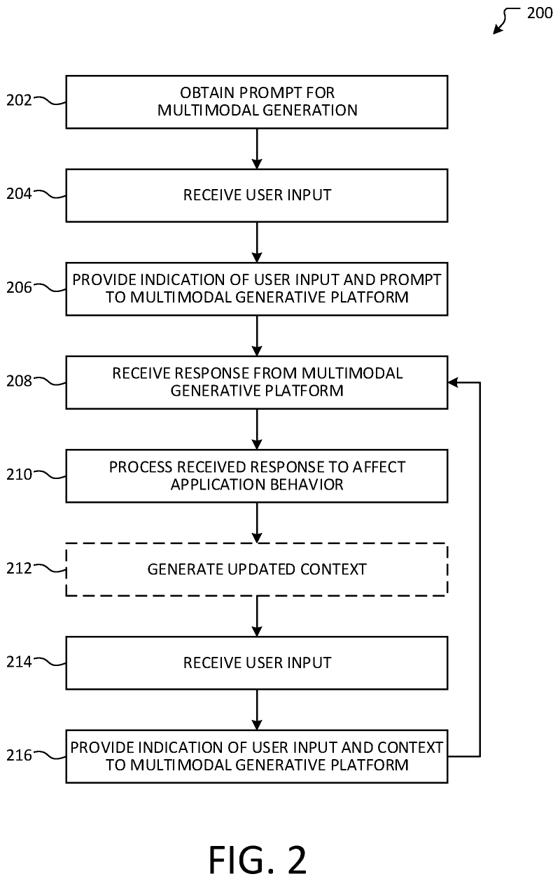

FIG. 2 illustrates an overview of an example method 200 for affecting an application based on model output from a multimodal machine learning model according to aspects described herein. In examples, aspects of method 200 are performed by a model interaction manager, such as model interaction manager 120 or model interaction manager 126 discussed above with respect to FIG. 1.

Method 200 begins at operation 202, where a prompt is obtained for multimodal generation. For example, the prompt may be obtained from a prompt store of a multimodal generative platform (e.g., prompt store 114 of multimodal generative platform 102). As another example, an application may be distributed with a set of prompts from which the prompt may be obtained. In a further example, at least a part of the prompt may be user-provided, for example as may be the case when a user is creating or revising a prompt for use with a given application. Thus, it will be appreciated that a prompt may be obtained according to any of a variety of techniques.

At operation 204, user input is received. Example user inputs include, but are not limited to, natural language input (e.g., textual input or spoken input), programmatic input, and/or gestural input, among any of a variety of other interactions with an application (e.g., productivity application 118 or productivity application 124 in FIG. 1). In some instances, the received user input may be multimodal, for example including multiple content types.

Flow progresses to operation 206, where an indication of the user input and the prompt are provided to a multimodal generative platform (e.g., multimodal generative platform 102). In examples, the received user input may be processed prior to providing it to the multimodal generative platform, for example to perform automated speech recognition or to perform gesture recognition. In other examples, such processing may instead be performed by the multimodal generative platform.

Moving to operation 208, a response is received from the multimodal generative platform. In examples, the response comprises model output that was generated by a machine learning engine (e.g., machine learning engine 112). In some instances, the model output may itself be multimodal or at least a part of it may have a different associated content type than the user input that was provided at operation 206. In other instances, at least a part of the model output may have the same content type as the provided user input.

At operation 210, the response is processed to affect application behavior accordingly. In examples, the processing performed at operation 210 depends on a content type of the model output. For example, if the model output includes natural language output, the natural language output may be presented to the user (e.g., as text or as spoken dialogue) or incorporated as content into a document of a productivity application. As another example, if the model output includes programmatic output, the programmatic output may be parsed or otherwise executed. In some instances, the model output includes multiple content types, such that operation 210 includes identifying multiple subparts therein and processing each subpart accordingly. In other instances, the model output may be programmatic output in which natural language output is encapsulated, such that executing, parsing, or otherwise processing the programmatic output will result in presentation of the natural language output to the user. While method 200 is described using the example of natural language output and/or programmatic output, it will be appreciated that similar techniques may be applied to any of a variety of content types.

In some instances, operation 210 may comprise determining that the model output is inadequate and handling such an identified issue accordingly. As discussed above, a failure indication may be presented to the user, for example indicating that the user may retry or reformulate the user input, that the user input was not correctly understood, or that the requested functionality may not be available. While example issues and associated issue handling techniques are described, it will be appreciated that any of a variety of other issues and/or issue handling techniques may be encountered/used in other examples.

Flow progresses to operation 212, where an updated context is generated. For example, the context may be updated in a context store, such as context store 122 or context store 128 discussed above with respect to FIG. 1. The updated context may include the prompt obtained at operation 202, the user input that was received at operation 204, and/or the response that was received at operation 208, among other examples. As discussed above, a context may maintain only a part of previous conversational agent interactions, such that later interactions (e.g., beyond a predetermined number of interactions or after a predetermined time) may be omitted. Operation 212 is illustrated using a dashed box to indicate that, in some examples, operation 212 may be omitted. For instance, a context may not be maintained, such that subsequent conversational agent interactions similarly utilize the prompt that was obtained at operation 202.

Eventually, flow progresses to operation 214, where subsequent user input is received. Accordingly, an indication of the received user input and context (or, in instances where a context is not maintained, the prompt obtained at operation 202) is provided to the multimodal generative platform. Aspects of operations 214 and 216 are similar to those discussed above with respect to operations 204 and 206, and are therefore not necessarily re-described in detail. In the described examples, the machine learning engine may not maintain a state associated with operations of method 200. Rather, any such state may be maintained by virtue of the context generated at operation 212 and/or the prompt that was obtained at operation 202. Thus, usage of the machine learning engine to generate associated model output may be said to be “zero-shot” in some examples.

Flow returns to operation 208, where a response is received from the multimodal generative platform based on the provided user input, such that it may be processed at operations 210 and 212 accordingly. Thus, flow may loop between operations 208-216 to process user input and enable conversational agent interactions using a multimodal machine learning model according to aspects described herein.

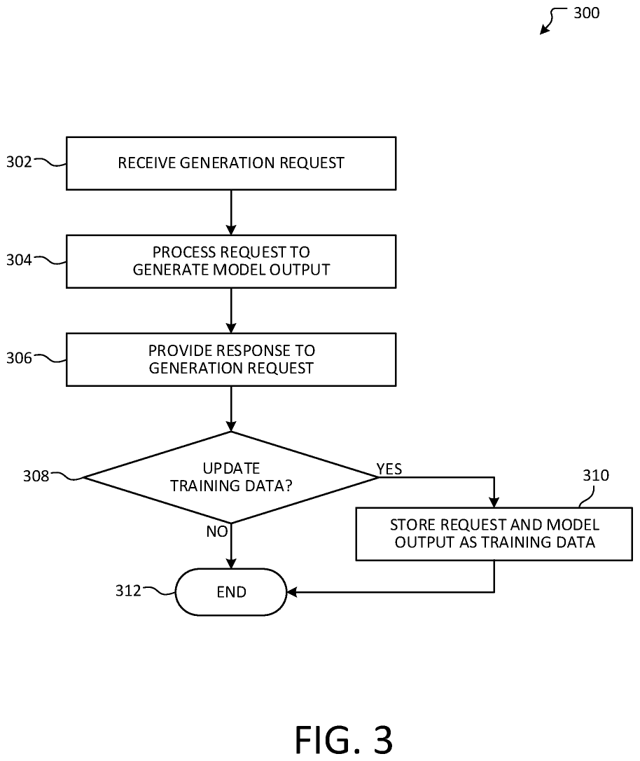

FIG. 3 illustrates an overview of an example method 300 for generating a multimodal response according to aspects described herein. In examples, aspects of method 300 are performed by a multimodal generative platform, such as multimodal generative platform 102 discussed above with respect to FIG. 1.

As illustrated, method 300 begins at operation 302, where a generation request is received. For example, the request may be received from a model interaction manager, such as model interaction manager 120 or model interaction manager 126 discussed above with respect to FIG. 1. In examples, the request is received as a result of performing aspects of operation 206 or operation 216 discussed above with respect to method 200 in FIG. 2. The request may include an indication of user input, as well as a prompt and/or context.

At operation 304, the request is processed to generate model output. For example, the request may be processed using a multimodal machine learning model of a machine learning engine, such as machine learning engine 112. In examples, processing the request comprises determining a machine learning model from a set of machine learning models, as may be the case when an application from which the request was received at operation 302 is associated with a specific machine learning model.

Flow progresses to operation 306, where a response is provided to the request that was received at operation 302. For example, the request may include the model output that was generated at operation 304. In some examples, the response may additionally or alternatively include a confidence level associated with the model output or an indication that the model output is inadequate.

At determination 308, it is determined whether to update training data associated with the machine learning engine. For example, the determination may comprise evaluating a confidence level associated with the model output that was generated at operation 304. In other examples, an indication may be received from a model interaction manager. Thus, it will be appreciated that it may be determined to update training data in any of a variety of scenarios.

Accordingly, if it is determined to update the training data, flow branches “YES” to operation 310, where at least a part of the request that was received at operation 302 is stored as training data in association with the generated model output. For example, the training data may be stored in a training data store, such as training data store 116 discussed above with respect to FIG. 1. As a result, the machine learning engine may be retrained using the training data, thereby improving model performance in the future. Flow then terminates at operation 312. Similarly, if it is instead determined not to update the training data, flow branches “NO” and also terminates at operation 312.

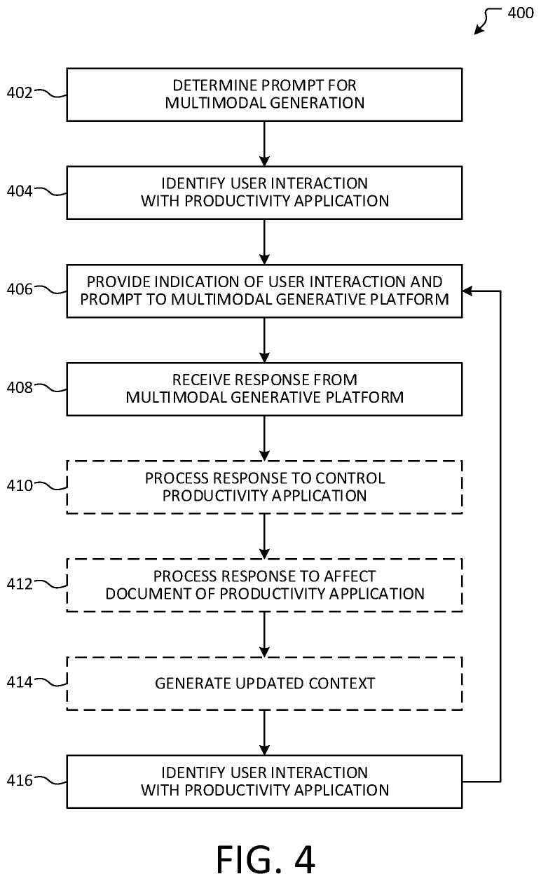

FIG. 4 illustrates an overview of an example method 400 for controlling a productivity application using a multimodal generative platform according to aspects described herein. In examples, aspects of method 400 are performed by a model interaction manager (e.g., model interaction manager 120 or model interaction manager 126 in FIG. 1) to affect behavior of a productivity application (e.g., productivity application 118 or productivity application 124).

It will be appreciated that a productivity application may provide any of a variety of controls, including, but not limited to, user interface elements, keyboard input, mouse input, gesture input, and/or voice input. Thus, in addition to such controls, aspects of method 400 may enable a user to access similar functionality via a multimodal machine learning model, for example using natural language input, where the resulting model output is processed according to aspects described herein to control the productivity application as directed by the user.

Method 400 begins at operation 402, where a prompt is determined for multimodal generation. For example, the prompt may be obtained from a prompt store of a multimodal generative platform (e.g., prompt store 114 of multimodal generative platform 102). As another example, the productivity application may be distributed with a set of prompts from which the prompt may be obtained. In a further example, at least a part of the prompt may be user-provided, for example as may be the case when a user is creating or revising a prompt for use with the productivity application. In some instances, different prompts may be associated with different aspects of the productivity application, as may be the case when different controls and/or functionality are available in different scenarios.

At operation 404, a user interaction with the productivity application is identified. Example user interactions include, but are not limited to, explicit natural language input (e.g., textual input or spoken input) to a conversational agent and/or a modification of a document within the productivity application. Further, it will be appreciated that gestural input, mouse input, and/or keyboard input, may additionally or alternatively be identified as a user interaction among any of a variety of other interactions. In some instances, the received user input may be multimodal, for example including both natural language input and gestural input.

Flow progresses to operation 406, where an indication of the user input and the prompt are provided to a multimodal generative platform (e.g., multimodal generative platform 102). In examples, the received user input may be processed prior to providing it to the multimodal generative platform, for example to perform automated speech recognition or to perform gesture recognition. In other examples, such processing may instead be performed by the multimodal generative platform.

Moving to operation 408, a response is received from the multimodal generative platform. In examples, the response comprises model output that was generated by a machine learning engine (e.g., machine learning engine 112). In some instances, the model output may itself be multimodal or at least a part of it may have a different associated content type than the prompt and/or indication of user input that was provided at operation 406. In other instances, at least a part of the model output may have the same content type as what was provided at operation 406.

At operation 410, the response is processed to control the behavior of the productivity application accordingly. As an example, if the model output includes programmatic output, the programmatic output may be parsed or otherwise executed to control functionality of the productivity application, for example to affect formatting, transitions, graphics or images, and/or formulas within a document, among other examples. For example, the programmatic output may include one or more API calls, may identify one or more user interface elements for actuation, or may include executable code to achieve functionality similar to that of other controls offered by the productivity application.

At operation 412, the response is processed to affect a document of the productivity application. For example, as compared to operation 410, operation 412 may affect a content of the document, rather than affecting the behavior of the productivity application itself (e.g., which may, indirectly, result in a change to a document of the productivity application). Accordingly, at least a part of the model output may be processed to add, remove, or change at least a part of the document of the productivity application. In examples, the model output includes multiple content types that are processed at operation 412, for example relating to text, images, audio, and/or video.

Operations 410 and 412 are each illustrated using dashed boxes to indicate that, in some examples, operation 410 and/or 412 may be omitted. For example, the processing performed at operations 410 and/or 412 may depend on a content type of the received model output. For example, if the model output includes natural language output, the natural language output may be presented to the user (e.g., as text or as spoken dialogue) and/or incorporated into a document of the productivity application at operation 412. Similarly, if the model output includes programmatic output, such programmatic output may be processed as discussed above with respect to operation 410.

Thus, in instances where the received model output includes multiple content types, multiple subparts therein may be identified and processed accordingly. In some instances, the model output may be programmatic output in which natural language output or other document-related output is encapsulated, such that executing, parsing, or otherwise processing the programmatic output will result in changes of the document within the productivity application accordingly.

While method 400 is described using the example of natural language output and/or programmatic output, it will be appreciated that similar techniques may be applied to any of a variety of content types. For example, model output received at operation 408 may include macros, image data, or other content usable to affect operation of the productivity application and/or a document therein responsive to the user interaction what was received at operation 404, other examples of which are discussed above.

In some instances, operation 410 and/or operation 412 may comprise determining that the model output is inadequate and handling such an identified issue accordingly. As discussed above, a failure indication may be presented to the user, for example indicating that the user may retry or reformulate a user interaction, that the user interaction was not correctly understood, or that the requested functionality may not be available (e.g., as may be the case when programmatic output is syntactically or semantically incorrect for a given productivity application). While example issues and associated issue handling techniques are described, it will be appreciated that any of a variety of other issues and/or issue handling techniques may be encountered/used in other examples.

Flow progresses to operation 414, where an updated context is generated. For example, the context may be updated in a context store, such as context store 122 or context store 128 discussed above with respect to FIG. 1. The updated context may include the prompt determined at operation 402, the user interaction that was received at operation 404, and/or the response that was received at operation 408, among other examples. As discussed above, a context may maintain only a part of previous conversational agent interactions, such that later interactions (e.g., beyond a predetermined number of interactions or after a predetermined time) may be omitted. Operation 414 is illustrated using a dashed box to indicate that, in some examples, operation 412 may be omitted. For instance, a context may not be maintained, such that subsequent conversational agent interactions similarly utilize the prompt that was obtained at operation 402.

Eventually, flow progresses to operation 416, where a subsequent user interaction is received. Aspects of operation 416 are similar to those discussed above with respect to operation 404 and are therefore not necessarily re-described in detail. As illustrated, flow returns to operation 406, where a request is provided to the multimodal generative platform. Thus, flow may loop between operations 406-416 to process user interactions to control productivity application functionality using a multimodal machine learning model according to aspects described herein (e.g., using a prompt and/or context, as may be maintained by operation 414).

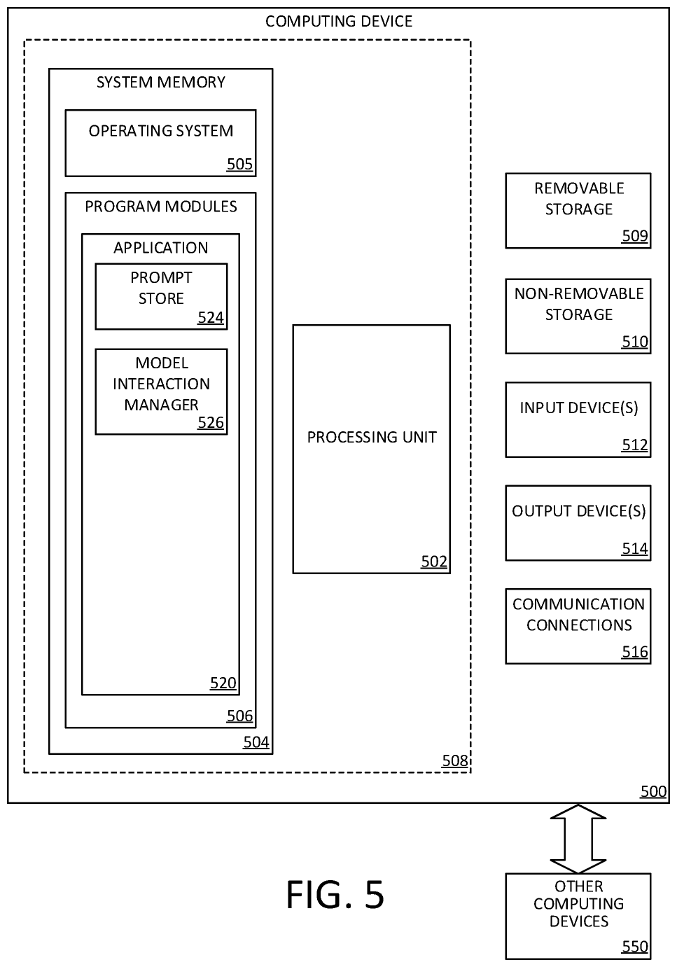

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including devices 104 and/or 106, as well as one or more devices associated with multimodal generative platform 102 discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store prompt store 524 and model interaction manager 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

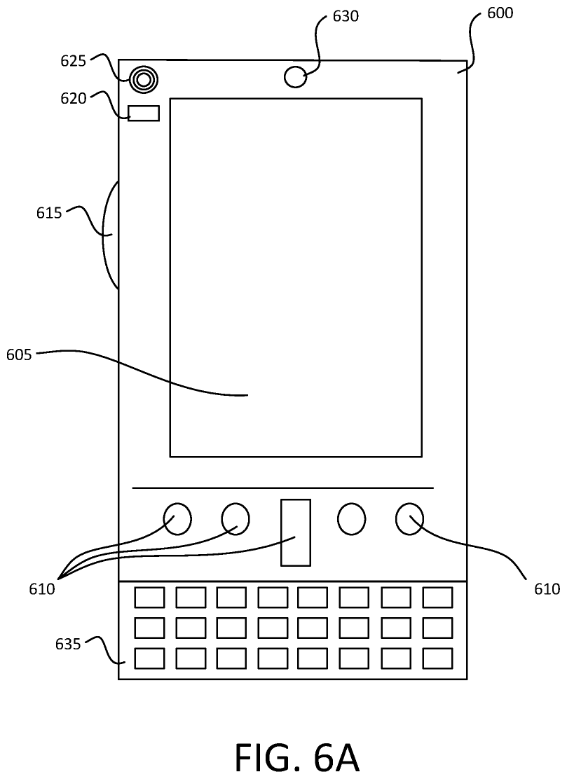

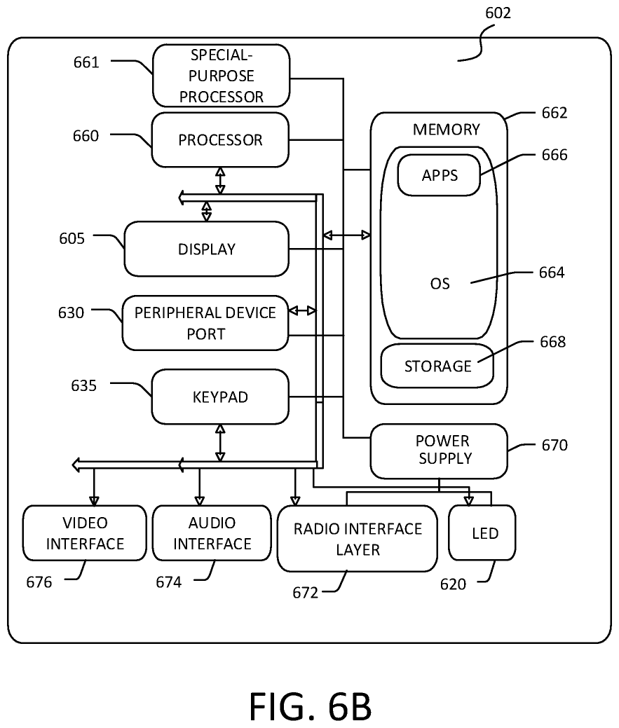

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments.

In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein.

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

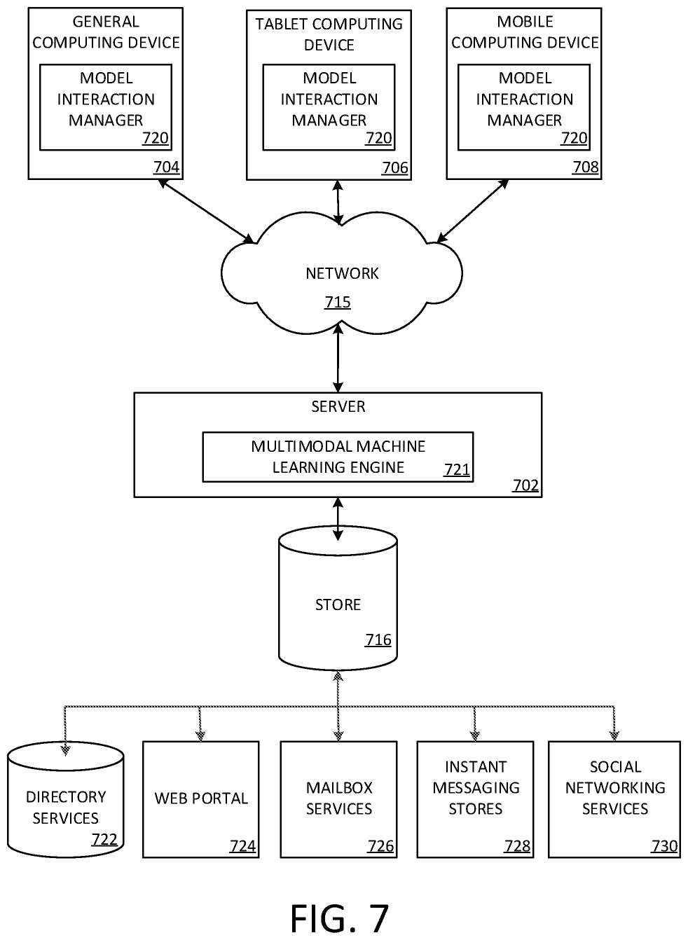

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730.

A model interaction manager 720 may be employed by a client that communicates with server device 702, and/or multimodal machine learning engine 721 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

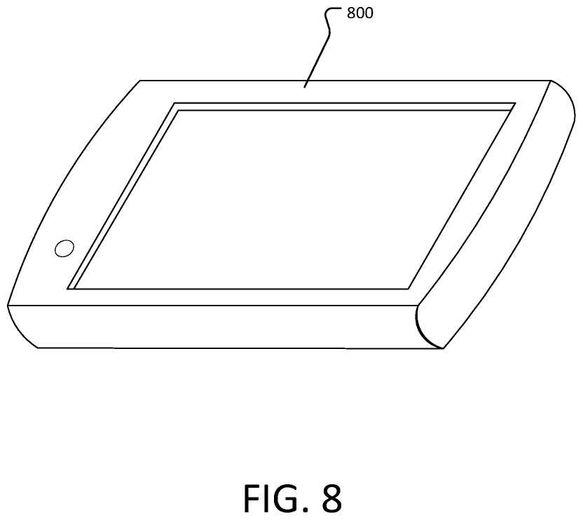

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: receiving, at a productivity application, a natural language user input; determining, based on the received user input, a model output associated with a multimodal machine learning model; processing the model output to control functionality of the productivity application; and as a result of processing the model output, modifying a productivity object of the productivity application. In an example, determining the model output comprises: providing, to a multimodal generative platform, an indication of the user input; and receiving, from the multimodal generative platform, the model output. In another example, determining the model output comprises: providing, to a multimodal generative platform, an indication of the user input; and receiving, from the multimodal generative platform, the model output. In a further example, the set of operations further comprises: receiving a second user input; determining, based on the second user input and the context, a second model output associated with the multimodal machine learning model; and processing the second model output to control functionality of the productivity application to modify the productivity object. In yet another example, the received user input and the second user input are the same; and the first model output and the second model output are different. In a further still example, the set of operations further comprises determining a prompt for priming the multimodal machine learning model, wherein the prompt is associated with at least one of the productivity application or the productivity object; and the model output is further determined based on the determined prompt. In another example, the model output is further determined based on: a prompt associated with the productivity application; and a context associated with a different productivity application. In a further example, modifying the productivity object of the productivity application comprises one or more of: changing formatting in the productivity object; changing a transition in the productivity object; adding graphical content to the productivity object; adding audio content to the productivity object; adding textual content to the productivity object; or generating a formula in the productivity object.

In another aspect, the technology relates to a method for controlling a productivity application using a multimodal machine learning model. The method comprises: receiving, at a productivity application, user input associated with a document; determining, based on the received user input, a model output of a multimodal machine learning model, wherein the model output does not include content to include in the document; processing the model output to control functionality of the productivity application; and as a result of processing the model output, modifying the document. In an example, the model output is a first model output and the method further comprises: storing the received user input and the determined model output as part of a context; receiving a second user input; determining, based on the second user input and the context, a second model output associated with the multimodal machine learning model; and processing the second model output to modify the document. In another example, the received user input and the second user input are the same; and the first model output and the second model output are different. In a further example, the model output includes a set of programmatic steps associated with the functionality of the productivity application; and processing the model output comprises executing the set of programmatic steps to control functionality of the productivity application.

In a further aspect, the technology relates to a method for controlling a productivity application using a multimodal machine learning model. The method comprises: receiving, at a productivity application, a natural language user input; determining, based on the received user input, a model output associated with a multimodal machine learning model; processing the model output to control functionality of the productivity application; and as a result of processing the model output, modifying a document of the productivity application. In an example, determining the model output comprises: providing, to a multimodal generative platform, an indication of the user input; and receiving, from the multimodal generative platform, the model output. In another example, the method further comprises storing the received user input and the determined model output as part of a context. In a further example, the method further comprises: receiving a second user input; determining, based on the second user input and the context, a second model output associated with the multimodal machine learning model; and processing the second model output to control functionality of the productivity application to modify the document. In yet another example, the received user input and the second user input are the same; and the first model output and the second model output are different. In a further still example, the method further comprises determining a prompt for priming the multimodal machine learning model, wherein the prompt is associated with at least one of the productivity application or the document; and the model output is further determined based on the determined prompt. In another example, the model output is further determined based on: a prompt associated with the productivity application; and a context associated with a different productivity application. In a further example, modifying the document of the productivity application comprises one or more of: changing formatting in the document; changing a transition in the document; adding graphical content to the document; adding audio content to the document; adding textual content to the document; or generating a formula in the document.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving, at a productivity application, a natural language user input;
determining, based on the received user input, a model output associated with a multimodal machine learning model;
processing the model output to control functionality of the productivity application; and
as a result of processing the model output, modifying a productivity object of the productivity application.

2. The system of claim 1, wherein determining the model output comprises:
providing, to a multimodal generative platform, an indication of the user input; and
receiving, from the multimodal generative platform, the model output.

3. The system of claim 1, wherein the set of operations further comprises:
storing the received user input and the determined model output as part of a context.

4. The system of claim 3, wherein the set of operations further comprises:
receiving a second user input;
determining, based on the second user input and the context, a second model output associated with the multimodal machine learning model; and
processing the second model output to control functionality of the productivity application to modify the productivity object.

5. The system of claim 4, wherein:
the received user input and the second user input are the same; and
the first model output and the second model output are different.

6. The system of claim 1, wherein:
the set of operations further comprises determining a prompt for priming the multimodal machine learning model, wherein the prompt is associated with at least one of the productivity application or the productivity object; and
the model output is further determined based on the determined prompt.

7. The system of claim 1, wherein the model output is further determined based on:
a prompt associated with the productivity application; and
a context associated with a different productivity application.

8. The system of claim 1, wherein modifying the productivity object of the productivity application comprises one or more of:
changing formatting in the productivity object;
changing a transition in the productivity object;
adding graphical content to the productivity object;
adding audio content to the productivity object;
adding textual content to the productivity object; or
generating a formula in the productivity object.

9. A method for controlling a productivity application using a multimodal machine learning model, the method comprising:
receiving, at a productivity application, user input associated with a document;
determining, based on the received user input, a model output of a multimodal machine learning model, wherein the model output does not include content to include in the document;
processing the model output to control functionality of the productivity application; and
as a result of processing the model output, modifying the document.

10. The method of claim 9, wherein the model output is a first model output and the method further comprises:
storing the received user input and the determined model output as part of a context;
receiving a second user input;
determining, based on the second user input and the context, a second model output associated with the multimodal machine learning model; and
processing the second model output to modify the document.

11. The method of claim 10, wherein:
the received user input and the second user input are the same; and
the first model output and the second model output are different.

12. The method of claim 9, wherein:
the model output includes a set of programmatic steps associated with the functionality of the productivity application; and
processing the model output comprises executing the set of programmatic steps to control functionality of the productivity application.

13. A method for controlling a productivity application using a multimodal machine learning model, the method comprising:
receiving, at a productivity application, a natural language user input;
determining, based on the received user input, a model output associated with a multimodal machine learning model;
processing the model output to control functionality of the productivity application; and
as a result of processing the model output, modifying a document of the productivity application.

14. The method of claim 13, wherein determining the model output comprises:
providing, to a multimodal generative platform, an indication of the user input; and
receiving, from the multimodal generative platform, the model output.

15. The method of claim 13, further comprising:
storing the received user input and the determined model output as part of a context.

16. The method of claim 15, further comprising:
receiving a second user input;
determining, based on the second user input and the context, a second model output associated with the multimodal machine learning model; and
processing the second model output to control functionality of the productivity application to modify the document.

17. The method of claim 16, wherein:
the received user input and the second user input are the same; and
the first model output and the second model output are different.

18. The method of claim 13, wherein:
the method further comprises determining a prompt for priming the multimodal machine learning model, wherein the prompt is associated with at least one of the productivity application or the document; and
the model output is further determined based on the determined prompt.

19. The method of claim 13, wherein the model output is further determined based on:
a prompt associated with the productivity application; and
a context associated with a different productivity application.

20. The method of claim 13, wherein modifying the document of the productivity application comprises one or more of:
changing formatting in the document;
changing a transition in the document;
adding graphical content to the document;
adding audio content to the document;
adding textual content to the document; or
generating a formula in the document.
